(19) United States
(12) Patent Application Publication
(10) Pub. No.: US 2007/0050912 A1
(43) Pub. Date: Mar. 8, 2007

(54) Reduction of turmeric and iodine staining

(76) Inventors: Joyce Monson Materniak, Hockessin, DE (US); Patrick Henry Fitzgerald, Pitman, NJ (US); Melea Rena Langley, Ringgold, GA (US); Peter Michael Murphy, Chadds Ford, PA (US); Aaron Frank Self, Ringgold, GA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/219,427

(22) Filed: Sep. 2, 2005

(51) Int. Cl. C11D 3/00

(52) U.S. Cl. 8/115.51

(57) ABSTRACT

A composition for reduction of turmeric and iodine complex stains comprising at least one stain resist agent and at least one stain resist enhancer, the enhancer comprising at least one of an alkali metal salt; alkali metal aryl salt; aryl sulfonic acid; urea; alkyl carbamate; and amide, alkylamide, dialkylamide, or cyclic amide of formic acid, of C₁ to C₆ alkanoic acids, or of C₁ to C₆ alkandioic acids.

### BACKGROUND OF THE INVENTION

The prevention and removal of stains on fibrous substrates, such as carpeting, textiles, and fabrics, is a major concern. However, mustard and iodine stains have been found to be extremely difficult both to prevent and remove, particularly from nylon, wool, and acrylics. Stains from BETADINE [1-vinyl-2-pyrrolidinone polymers iodine complex] are a problem for carpets and textiles in the health care segment. Available treatments for providing stain resistance provide good stain resistance for acid dyes, such as the FD&C Red Dye #40, used, for instance, in beverages and foods. However, the current stain resist products do not provide good stain resistance to stains from mustard or iodine complexes. The difficulty experienced in the prevention and removal of turmeric stains is well documented. Murphy et al. in U.S. Pat. No. 6,300,299 describe a procedure for removing turmeric stains involving the use of an oxidizing solution such as aqueous hydrogen peroxide applied to the stained area and subsequent exposure of the stained area to ultraviolet radiation from a lamp. However effective such stain removal methods are, it would be advantageous to provide a treatment that offered sufficiently improved stain resistance that a spill could be easily wiped up with detergent and water.

Pacifici, in U.S. Pat. Nos. 5,843,328 and 6,616,856, added a naphthalene sulfonated salt to bath compositions for finishing carpet products with a stainblocker and fluorocarbon-based repellant in a one-step process, as an anti-coalescing aid to stabilize the bath composition. In Research Disclosure RD 319044 (Anonymous), sodium sulfate-containing baths (limited to 5 to 10 g/L Na₂SO₄) were utilized to improve the durability of resistance to FD&C Red #40 stain. The bath, having a pH of 2 to 3, contained 0.1 to 2 wt. % (based on the weight of the carpet fiber) of a mixture of a styrene/maleic anhydride copolymer and a sulphonated phenol-formaldehyde condensate. There was no reference to improved stain resistance to mustard or iodine complexes.

Clearly there is a need for better treatment compositions and processes that can be used on fibrous substrates for the prevention or reduction of stains from turmeric, such as from mustard, and of stains from iodine complexes. The present invention provides such compositions and processes.

### SUMMARY OF THE INVENTION

The present invention comprises a composition comprising at least one stain resist agent and at least one stain resist enhancer, said enhancer comprising at least one of an alkali metal salt; alkali metal aryl salt; aryl sulfonic acid; urea; alkyl carbamate; and amide, alkylamide, dialkylamide, or cyclic amide of formic acid, of C₁ to C₆ alkanoic acids, or of C₁ to C₆ alkandioic acids, said composition reducing turmeric stains or iodine complex stains.

The present invention further comprises a method for providing stain resistance to turmeric or iodine complexes in substrates comprising contacting the substrate with a medium containing a composition as described above.

The present invention further comprises a substrate treated with a composition as described above.

### DETAILED DESCRIPTION

Tradenames and trademarks are indicated herein by capitalization. The terms “turmeric stain” and “mustard stain” as used herein mean yellow turmeric stains from any source. Yellow turmeric stains are found in various foods in addition to mustard, such as chicken soup, pickles, and spicy sauces. The term “iodine complex stain” is used herein to mean stains from 1-vinyl-2-pyrrolidinone polymers iodine complex, also known as providone iodine, or BETADINE. The present invention provides a composition and process to reduce or resist such stains.

This invention comprises a composition and process for the effective reduction of stains, particularly turmeric stains and iodine complex stains, that are resistant to simple washing, wiping, or the use of detergent-based spot stain removers. The process of this invention is directed towards fibrous substrates. Fibrous substrates include fibers, fabrics, fabric blends, carpet, textiles, nonwovens, leather, and paper. Particular examples include nylon 6, nylon 66, wool fabrics, and acrylics as used in carpets, rugs, fabrics, and textiles, including upholstery, clothing, and the like.

The present invention comprises a composition comprising at least one stain resist agent and at least one stain resist enhancer. Typical known or commercially available stain resist agents, or blends thereof, are suitable for use herein. Suitable stain resist enhancers comprise alkali metal salts; alkali metal aryl salts; aryl sulfonic acids; urea; alkyl carbamate; and the amides, alkyl amides, dialkyl amides, and cyclic amides of formic acid, of C₁ to C₆ alkanoic acid, and of C₁ to C₆ alkandioic acid.

Typical commercially available stain resist agents, or blends thereof, or other stain resist agents known in the art are suitable for use in the present invention. These comprise a sulfonated phenolic resin or condensate, a partially sulfonated novalac resin, a polymer or copolymer of methacrylic acid or esters thereof, a copolymer of maleic anhydride with olefin or vinyl ether, a hydrolyzed ethylenically unsaturated aromatic/maleic anhydride copolymer, and combinations thereof.

Examples are disclosed in U.S. Pat. Nos. 5,851,595 and 6,613,862. Preferred stain resist agents include dispersions of a blend of hydrolyzed maleic anhydride copolymers, sulfonated phenolic resins, and surfactants, prepared as in U.S. Pat. Nos. 4,883,839; 4,948,650 and 5,032,136. In particular use of a hydrolyzed ethylenically unsaturated aromatic/maleic anhydride copolymer, or a copolymer of an olefin or a vinyl ether with maleic anhydride are preferred. Also preferred is a dispersion of a blend of hydrolyzed maleic anhydride copolymers, sulfonated phenolic resin, aqueous solution of a partial sodium salt of a hydrolyzed octene/maleic anhydride copolymer, and surfactant as disclosed in U.S. Pat. No. 5,654,068.

An additional example of a preferred stain resist agent is a dispersion of a sulfonated phenol-formaldehyde condensation product as disclosed and prepared as in U.S. Pat. No. 4,833,009. Other suitable stain resist agents (or stain blockers) for use herein include those disclosed by Scholla comprising hydrolyzed vinyl aromatic-maleic anhydride polymers and hydrolyzed styrene maleic anhydride polymers in U.S. Pat. No. 5,096,747. Pechhold, in U.S. Pat. No. 5,460,887, described styrene/maleic anhydride copolymer and similar stain resist compositions also suitable for use in the present invention. Partially sulfonated novalac resins as prepared in U.S. Pat. No. 4,875,901 and EP 797699 are also useful herein. Additional suitable stain resist agents include those of Pechhold in U.S. Pat. No. 5,712,348 disclosing maleic acid copolymers with fluorinated thioether end-caps and U.S. Pat. No. 6,238,792 disclosing maleic acid terpolymers.

Especially preferred stain resist agents include sulfonated phenolic condensation products, hydrolyzed copolymers of maleic anhydride with at least one ethylenically-unsaturated comonomer such as a partial sodium salt of a hydrolyzed octene/maleic anhydride copolymer, or blends thereof.

Stain resist enhancers suitable for use in the present invention comprise alkali metal salts; alkali metal aryl salts; aryl sulfonic acids; urea; alkyl carbamate; and amides, alkyl amides, dialkyl amides and cyclic amides of formic acid, of C₁ to C₆ alkanoic acids, and of C₁ to C₆ alkandioic acids. Preferably the stain resist enhancer is water-soluble.

Suitable salts include salts comprising alkali metal cations in combination with anions such as sulfate, aryl sulfonate, phosphate, borate, chloride, polyphosphate, nitrate, acetate, citrate, benzoate, tetrafluoroborate, mono and di-alkyl phosphate. Preferred inorganic salts are sodium sulfate and potassium sulfate. In contrast with the earlier work of Payet, divalent salts, such as magnesium sulfate, are ineffective as stain resist enhancers.

Suitable aryl salts are sulfonated aromatic compounds containing from about 6 to about 10 carbon atoms, optionally with alkyl substituents. Preferred aryl sulfonates include sodium aryl sulfonate, potassium aryl sulfonate, sodium toluene sulfonate and sodium xylene sulfonate. The aryl sulfonates are added as the free sulfonic acids, e.g., p-toluenesulfonic acid or as their alkali metal salts, preferably the sodium salt. The sulfonated aromatic compounds, optionally with alkyl substituents, are added as the free sulfonic acid or as their alkali metal salt, to the bath or other treating medium.

Further stain resist enhancers are urea, alkyl carbamate and amides. Suitable amides include the amides, alkylamides, dialkylamides, and cyclic amides of formic acid, of C₁ to C₆ alkanoic acids, and of C₁ to C₆ alkandioic acids. Examples include formamide, caprolactam, malonamide, acetamide, dimethylacetamide, biuret, dimethylformamide, succinamide, succinimide, and other similar amides. These enhancers have a typical molecular weight of less than about 200 grams/mole, are water soluble, and are neither strongly acidic nor strongly basic.

The amount of stain resist enhancer employed is an amount sufficient to provide a concentration of from about 2.5 g/L to about 35 g/L in the bath or other treating medium. Preferably, the concentration is from about 5 g/L to about 30 g/L, more preferably from about 11 g/L to about 30 g/L, and even more preferably from about 15 g/L to about 25 g/L. The present invention also includes combinations of one or more stain resist enhancers as described above.

The compositions used in the treatment or contacting medium comprise at least one stain resist agent and at least one stain release enhancer. The components of the present invention may be added separately or as a premix to the bath or other treatment medium. The order of addition is not critical but a preferred sequence is the salt (dissolved in water), followed by the stain resist, and then pH adjustment. Optionally, other conventional additives may be added to the treatment medium, such as chemicals to adjust pH (for instance urea sulfate, or other acid), sequestering agents (such as ethylene diamine tetraacetic acid), additional surfactants, leveling agents, and the like. The use of such additives is well known to those skilled in the art.

The present invention further comprises a method of providing resistance to turmeric stains and iodine complex stains comprising contacting the substrate with a composition comprising a stain resist agent and a stain resist enhancer as described above. The fibrous substrate is passed through the application process and the stain resist is exhausted or deposited onto the fabric. The present invention comprises the use of a solution of the stain resist agent and stain resist enhancer, optionally with other additives, in a bath or other treatment medium. The composition is applied to the fibrous substrate in a process such as an exhaust method, such as a Beck or Winch method, or by use of other conventional application methods known in the art. These include continuous methods such as, but not limited to, Flex-nip, pad, spray, or foam application. Continuous methods of application can include steaming after application of the stain resist agent.

Conventional bath conditions can be used. For example, for an exhaust application, an application period of from about 5 minutes to about 30 minutes and preferably about 15 minutes is employed. A bath:fiber weight ratio of from about 40:1 to about 2:1 is used. A bath pH of from about 1 to about 9, preferably about 1.5 to about 5.0, and more preferably about 1.8 to about 3.0 is used. The bath temperature is from about 160° F. to about 200° F. (from about 71° C. to about 93° C.), and preferably about 190° F. (about 88° C.). The solids weight ratio of the stain resist enhancer to the stain resist agent in the application medium is from about 1:0.7 to about 1:0.02, preferably from about 1:0.13 to about 1:0.03, and more preferably from about 1:0.1 to about 1:0.04. Lower pH and higher temperature improve exhaust efficiency but the more extreme conditions may adversely effect equipment. These conditions are balanced with operating and maintenance costs. After application of the composition of the present invention, the fibrous substrate is rinsed and dried conventionally.

Other surface treatment agents may also be applied simultaneously or sequentially to the fibrous substrate. Such additional components comprise compounds or compositions that provide surface effects such as no iron, easy to iron, shrinkage control, wrinkle free, permanent press, moisture control, softness, strength, anti-slip, anti-static, anti-snag, anti-pill, stain repellency, stain release, odor control, antimicrobial, sun protection, and similar effects. One or more such treating agents or finishes can be combined with the composition of the present invention and applied to the fibrous substrate. Other additives commonly used with such treating agents or finishes may also be present such as surfactants, pH adjusters, cross linkers, blocked isocyanates, hydrocarbon extenders, wetting agents, wax extenders, and other additives known by those skilled in the art. Suitable surfactants include anionic, cationic, and nonionic.

The present invention further comprises a substrate treated with the composition of the present invention as disclosed above. Suitable for use in the present invention are fibrous substrates. Such substrates include fibers, fabrics, fabric blends, textiles, carpet, nonwovens, leather and paper. The term “fiber” includes fibers and yarns, before and after spinning, of a variety of compositions and forms, and includes pigmented fibers and pigmented yarns. By “fabrics” is meant natural or synthetic fabrics, or blends thereof, composed of fibers such as cotton, rayon, silk, wool, polyester, polypropylene, polyolefins, nylon, and aramids such as “NOMEX” and “KEVLAR.” By “fabric blends” is meant fabric made of two or more types of fibers. Typically these blends are a combination of at least one natural fiber and at least one synthetic fiber, but also can be a blend of two or more natural fibers or of two or more synthetic fibers. Carpets include for example those of cotton, wool, silk, nylon, acrylics, aromatic polyamides, polyesters, jute, sisal, and other cellulosics.

The present invention is useful to reduce or resist turmeric stains and iodine complex stains in fibrous substrates. These stains are resistant to washing and spot stain removers. The present invention combining a stain resist agent and stain resist enhancer has been found to be particularly effective against these stains, as well as coffee stains. Further the compositions maintain excellent resistance to red dye stains in fibrous substrates. The present invention is useful on a variety of fibrous substrates such as carpets, textiles, and fabrics benefiting consumers in multiple usage situations. Additionally the invention in especially useful in the health care segment in reducing iodine complex stains.

### Materials and Test Methods

The following materials and test methods were used in the Examples herein.

Carpet 1

The carpet used for application and testing was a level loop carpet made with 1245 denier nylon 6,6. The yarn was SUPERBA heat-set at 265° F. (129° C.), having a yarn twist of 4.5 turns/inch (1.8 turns/cm), 7/32 inch (5.6 mm) pile height, 28 oz./yd² (0.95 kg/m²) fiber face weight, and Beck dyed a light yellow color using 0.0051% Tectilon Orange 3G 200%, 0.0003% Red 2B 200%, and 0.0004% Blue 4R 200%.

Carpet 2

The carpet used for application and testing was cut-pile carpet made with nylon 6 yarn. The carpet was 29 oz (983 g/m² and was mock dyed.

BETADINE Solution was a 10% solution of 1-vinyl-2-pyrrolidine polymers iodine complex sold by the Purdue Frederick Company, Stamford, Conn.

Test Method 1—Mustard Stain Test Method

A 2-inch (5.1 cm) brass ring was placed in the center of a 4-6 inch (10.2-15.3 cm) square sample of carpet which was on a non-absorbent surface. For the mustard stain test, French's yellow mustard (15 g, from Reckitt Benckiser, Inc., Wayne N.J.) was used to create a stain by placing the mustard in the middle of the brass ring on the carpet, and then spreading and pressing the stain into the carpet surface. After setting for 24 hours, the excess mustard was (a) scraped off, (b) thoroughly rinsed with water, (c) extracted, and (d) air-dried for 24 hours on a non-absorbent surface. Mustard stains were then rated either with a visual stain rating scale (AATCC Red 40 Stain Scale) from AATCC Test Method 175 or using a delta E color difference measurement. A visual rating of 10 (complete stain removal) to 1 (maximum or unchanged stain) was used that approximated the AATCC Red 40 Stain Scale (Test Method #175) with the mustard stains having the same discoloration as the numbered colored film, though discoloration of the mustard stain was yellow while the discoloration of AATCC Red 40 Stain Scale was red. On this scale, a higher number indicates superior stain resistance. For color measurement with the delta E color difference, the color of each control and test carpet was measured both before and after the mustard stain test. The initial color of the carpet (L*, a*, b*) was measured on an unstained piece of carpet. The delta E is the difference between the color of the unstained and stained samples, expressed as a positive number. The color difference was measured using a Minolta CHROMA METER CR-410 (Minolta Corporation, Ramsey N.J.) and the average delta E was reported. Control carpets were of the same color and construction as the carpets for test items. A delta E reading of zero represents no color difference between two samples. A larger delta E value indicates a color difference between two samples. Color measurement with delta E is discussed in AATCC Evaluation Procedure 7 “Instrumental Assessment of the Change in Color of a Test Specimen”. Using this evaluation, a lower delta E indicates superior stain resistance.

Test Method 2—BETADINE Stain Test Method

Stain testing with BETADINE was conducted on carpet samples 15 cm by 15 cm. Stain resistance was evaluated using a procedure based on the American Association of Textile Chemists and Colorists (AATCC) Method 175, “Stain Resistance: Pile Floor Coverings.” The staining solution was BETADINE (see Materials, above). The carpet sample to be tested was placed on a flat non-absorbent surface and a hollow plastic cylinder having a 2-inch (5-cm) diameter was placed tightly over the carpet sample. BETADINE staining solution (20 mL) was poured into the cylinder, which was previously placed on the carpet. The BETADINE stain was gently worked into the carpet sample. The cylinder was then removed and the stained carpet sample was allowed to sit undisturbed for 24 hours. Then the carpets were rinsed thoroughly under cold tap water for at least 10 minutes until the rinse water was clear. The carpet samples were extracted, and air-dried for 24 hours on a non-absorbent surface. The BETADINE stains obtained by this procedure were rated either with a visual stain rating scale (AATCC Red 40 Stain Scale) from AATCC Test Method 175 or using a measurement of delta E color difference. A visual rating of 10 (complete stain removal) to 1 (maximum or unchanged stain) was obtained by using the AATCC Red 40 Stain Scale (Test Method #175) with the BETADINE stains having the same discoloration as the numbered colored film. On this scale, a higher number indicates superior stain resistance. For color measurement with the delta E color difference, the color of each control and test carpet was measured both before and after the BETADINE stain test. The initial color of the carpet (L*, a*, b*) was measured on an unstained piece of carpet. The delta E is the difference between the color of the unstained and stained samples, expressed as a positive number. The color difference was measured using a Minolta CHROMA METER CR-410 (Minolta Corporation, Ramsey, N.J.) and the average delta E was reported. Control carpets were of the same color and construction as the carpets for test items. A delta E reading of zero represents no color difference between two samples. A larger delta E value indicates a color difference between two samples. Color measurement with delta E is discussed in AATCC Evaluation Procedure 7 “Instrumental Assessment of the Change in Color of a Test Specimen”. Using this evaluation, a lower delta E indicates superior stain resistance.

Test Method 3—Coffee Stain Test Method

Carpet samples, 6.76×6.76-inch (17.2×17.2 cm) squares of dyed carpet, were cut and placed pile side up on a non-absorbent surface. The pile was cleaned of any unattached materials by vacuuming. ORIGINAL MAXWELL HOUSE ground coffee (33.8 g, available from Maxwell House Coffee Co., Tarrytown N.Y.) was placed into a standard 10-cup (80 fl. oz, 2.2 L) coffee filter. Deionized water (1266.2 g) was added and the coffee brewed according to the manufacturers' directions. The pH of the coffee was adjusted to 5.0 using aqueous solutions containing either 30% aqueous sodium hydrogen sulfate or 10% sodium hydroxide as needed. The coffee was poured into a suitable volumetric dispenser, capable of dispensing 50-mL portions and the dispenser placed in a hot water bath at 62° C. The coffee was allowed to come to a temperature of 140° F.+/−5° F. (60°+/−2.8° C.) and remain at that temperature for 30+/−5 minutes prior to staining. A ring, in the shape of an open-ended cylinder was used, having a diameter of the smaller opening of 2.75 inch (7 cm). Such a ring is described for a different purpose in AATCC Test Method 175. The ring was placed at the center of the carpet sample, with the smaller diameter opening against the pile. The coffee dispenser was set to measure 50 mL, and purged once prior to staining. With the ring pressed down into the pile, 50 mL of coffee was transferred into a container and immediately poured into the ring and onto the carpet. The coffee was worked into the carpet evenly and thoroughly with the base of the cup. The coffee was allowed to stain the carpet for 4 hours+/−20 minutes. Then the carpet samples were thoroughly rinsed in cold water for at least 10 minutes until the rinse water was clear. The carpet samples were extracted, and air-dried for 24 hours on a non-absorbent surface.

The coffee stain obtained by this procedure was rated either with a visual stain rating scale (AATCC Gray Scale for Staining) from AATCC Test Method 175 or using a delta E color difference measurement. A visual rating of 5 (complete stain removal) to 1 (maximum or unchanged stain) was obtained using the AATCC Gray Scale for Staining (AATCC Evaluation Procedure 2). On this scale, a higher number indicates superior stain resistance.

For color measurement with delta E color difference, the color of each control and test carpet was measured both before and after the coffee stain test. The initial color of the carpet (L*, a*, b*) was measured on an unstained piece of carpet. The delta E is the difference between the color of the unstained and stained samples, expressed as a positive number. The color difference was measured using a Minolta CHROMA METER CR-410 (Minolta Corporation, Ramsey N.J.). Color readings were taken on several areas on the carpet sample, and the average delta E was reported. Control carpets were of the same color and construction as the carpets for test items. A delta E reading of zero represents no color difference between two samples. A larger delta E value indicates a color difference between two samples. Color measurement with delta E is discussed in AATCC Evaluation Procedure 7 “Instrumental Assessment of the Change in Color of a Test Specimen”. Using this evaluation, a lower delta E indicates superior stain resistance.

Test Method 4—Cherry KOOL-AID Stain Test Method

Cherry KOOL-AID stain testing was conducted on carpet samples 15 cm by 15 cm. Acid dye stain resistance was evaluated using a procedure based on the American Association of Textile Chemists and Colorists (AATCC) Method 175, “Stain Resistance: Pile Floor Coverings.” A staining solution was prepared by mixing sugar sweetened cherry KOOL-AID (36.5 g) and 500 mL water. KOOL-AID is a trademark of Kraft General Foods, Inc., White Plains N.Y. The carpet sample to be tested was placed on a flat non-absorbent surface and a hollow plastic cylinder having a 2-inch (5-cm) diameter was placed tightly over the carpet sample. KOOL-AID staining solution (20 mL) was poured into the cylinder, which had been previously placed on the carpet sample. The stain was gently worked into the carpet. The cylinder was then removed and the stained carpet sample was allowed to sit undisturbed for 24 hours. Then the carpets were rinsed thoroughly under cold tap water for at least 10 minutes until the rinse water was clear. The carpet samples were extracted, and air-dried for 24 hours on a non-absorbent surface. The KOOL-AID stains obtained by this procedure were rated either with a visual stain rating scale (AATCC Red 40 Stain Scale) from AATCC Test Method 175 or using a measurement of delta E color difference. A visual rating of 10 (complete stain removal) to 1 (maximum or unchanged stain) was obtained by using the AATCC Red 40 Stain Scale (Test Method #175) with the KOOL-AID stains having the same discoloration as the numbered colored film. Using this scale, a higher number indicates superior stain resistance.

For color measurement with the delta E color difference, the color of each control and test carpet was measured both before and after the KOOL-AID stain test. The initial color of the carpet (L*, a*, b*) was measured on an unstained piece of carpet. The delta E is the difference between the color of the unstained and stained samples, expressed as a positive number. The color difference was measured using a Minolta CHROMA METER CR-410 (Minolta Corporation, Ramsey N.J.). Color readings were taken on several areas on the carpet sample, and the average delta E was reported. Control carpets were of the same color and construction as the carpets for test items. A delta E reading of zero represents no color difference between two samples. A larger delta E value indicates a color difference between two samples. Color measurement with delta E is discussed in AATCC Evaluation Procedure 7 “Instrumental Assessment of the Change in Color of a Test Specimen”. Under this evaluation, a lower delta E indicates superior stain resistance.

### EXAMPLES

### Example 1

A stain resist composition was prepared containing 10.2% by weight of a hydrolyzed styrene/maleic anhydride/methyl styrene terpolymer, 12.3% by weight of sulfonated phenol formaldehyde condensate, 4.0% by weight of alpha olefin sulfonate, and 73.5% by weight water. Carpet 1 as described above was treated with this stain resist composition using a Beck exhaust application, using a 30:1 bath:fiber weight ratio at pH 3.0 (adjusted with Autoacid A-10) unless otherwise noted in the Tables. The stain resist concentration was 15% (4% on a 100% solids basis) based on the weight of the dry fiber weight of the carpet. Sodium sulfate or sodium chloride was added to the bath to provide a concentration of 25 g/L. Cut carpet samples (4 to 6 inch squares, 10 to 15 cm) were immersed in the bath, and the bath temperature was raised to 190° F. (88° C.), then held at 190° F. (88° C.) for 15 min. The samples were removed from the application bath, rinsed with water, extracted, and dried.

The samples were stained with mustard and tested for stain resistance according to Test Method 1. The samples were also stained with BETADINE and tested for stain resistance according to Test Method 2. The resulting data is shown in Table 1 below.

### Examples 2-20

Carpet samples were prepared, stained, and rated as described in Example 1 using the stain resist composition described in Example 1 except that, as listed in Table 1 instead of the 25 g/L sodium sulfate, various concentrations of stain resist enhancers as denoted in Table 1 were used. Testing was as described in Example 1. Results are shown below in Table 1.

### Examples 21-23

Carpet samples were prepared, stained, and rated as described in Example 1 using the stain resist composition described in Example 1, except that various application pH values were used instead of application pH of 3.0. The carpet sample for Example 21 was applied at pH 2.0. The carpet sample for Example 22 was applied at pH 2.5. The carpet sample for Example 23 was applied at pH 4.0. All tests were as described in Example 1 using Test Methods 1 and 2. Results are shown below in Table 1.

### Comparative Example A

Carpet samples were prepared, stained, and rated as described in Example 1 except that no stain resist composition or stain resist enhancer were added to the bath. Testing was as described in Example 1 using Test Methods 1 and 2. Results are shown below in Table 1.

### Comparative Examples B and C

Carpet samples were prepared, stained, and rated as described in Example 1 using the stain resist composition of Example 1, except that no stain resist enhancer was added to the bath. Two different stain resist composition concentrations were used in the bath as listed in Table 1. Testing was as described in Example 1 using Test Methods 1 and 2. Results are shown below in Table 1.

### Comparative Example D

Carpet samples were prepared, stained, and rated as described in Example 1 using the stain resist composition of Example 1, except that magnesium sulfate (25 g/L) was added to the bath as the stain resist enhancer instead of sodium sulfate. Testing was as described in Example 1 using Test Methods 1 and 2. Results are shown below in Table 1.

### Comparative Example E

Comparative Example E was prepared, stained, and rated as described in Example 1 except that no stain resist composition was present, only the sodium sulfate salt (stain resist enhancer). Testing was as described in Example 1 using Test Methods 1 and 2. Results are shown below in Table 1.

TABLE 1

| | Bath Contents and Concentrations | | | | | |
|---|---|---|---|---|---|---|
| | Stain | | | | | |
| | Resist | | | | | |
| | (% owf*) | | | | | |
| | (100% | | En- | | Mustard | |
| Ex. | solids | Stain Resist | hancer | Bath | Stain | BETADINE |
| # | basis) | Enhancer | (g/L) | pH | Rating | Stain Rating |

EXAMPLES

| | | | | | | |
|---|---|---|---|---|---|---|
| 1 | 4 | Sodium sulfate | 25 | 3.0 | 10 | 5 |
| 6 | 4 | Sodium sulfate | 5 | 3.0 | 6 | 1 |
| 12 | 4 | Sodium sulfate | 10 | 3.0 | 9 | 7 |
| 13 | 4 | Sodium sulfate | 12 | 3.0 | 9 | 6 |
| 7 | 4 | Sodium sulfate | 15 | 3.0 | 7 | NT |
| 21 | 4 | Sodium sulfate | 25 | 2.0 | 8 | NT |
| 22 | 4 | Sodium sulfate | 25 | 2.5 | 7 | NT |
| 23 | 4 | Sodium sulfate | 25 | 4.0 | 7 | NT |
| 15 | 4 | p-toluene | 2.5 | 3.0 | 9.5 | 7 |
| | | sulfonic acid | | | | |
| 2 | 4 | p-toluene | 5 | 3.0 | 9 | 7 |
| | | sulfonic acid | | | | |
| 8 | 4 | p-toluene | 12.5 | 3.0 | 7 | 5 |
| | | sulfonic acid | | | | |
| 9 | 4 | p-toluene | 25 | 3.0 | 8 | 6 |
| | | sulfonic acid | | | | |
| 5 | 4 | Sodium p- | 12.5 | 3.0 | 7 | 7 |
| | | toluene | | | | |
| | | sulfonate | | | | |
| 14 | 4 | Sodium xylene | 5 | 3.0 | 9 | 6 |
| | | Sulfonate | | | | |
| 3 | 4 | Sodium xylene | 12.5 | 3.0 | 9 | 6 |
| | | sulfonate | | | | |
| 10 | 4 | Sodium xylene | 25 | 3.0 | 6 | 2 |
| | | sulfonate | | | | |
| 4 | 4 | Urea | 5 | 3.0 | 8 | 7 |
| 11 | 4 | Urea | 25 | 3.0 | 7 | 3 |
| 16 | 4 | Formamide | 12.5 | 3.0 | 9 | 6 |
| 17 | 4 | Caprolactam | 15 | 3.0 | 8 | 2 |
| 18 | 4 | Alkyl | 15 | 3.0 | 9 | 7 |
| | | carbamate | | | | |
| 19 | 4 | Malonamide | 15 | 3.0 | 9 | 6 |
| 20 | 4 | Dimethyl- | 15 | 3.0 | 8 | 3 |
| | | Acetamide | | | | |

COMPARATIVE EXAMPLES

| | | | | | | |
|---|---|---|---|---|---|---|
| A | 0 | None | — | 3.0 | 1 | 1 |
| B | 1.2 | None | — | 3.0 | 6 | NT |
| C | 4 | None | — | 3.0 | 6 | 1 |
| D | 4 | Magnesium | 25 | 3.0 | 6 | NT |
| | | sulfate | | | | |
| E | 0 | Sodium sulfate | 25 | 3.0 | 1 | 1 |

NT indicates not tested
*owf indicates percent by weight based on the weight of the fiber.

Table 1 shows that stain resist compositions comprising a stain resist agent and one of sodium sulfate, p-toluene sulfonic acid, sodium p-toluene sulfonic acid, sodium xylene sulfonate, urea, formamide, caprolactam, alkyl carbamate, malonamide, and dimethylacetamide as a stain resist enhancer showed a reduction in staining by mustard and BETADINE stains. Comparative Example A containing no stain resist agent and no stain resist enhancer showed a high level of mustard and BETADINE staining. Comparative Examples B and C, containing the same stain resist agent but no stain resist enhancer showed poorer performance than the examples of the present invention. Comparative Example D containing the same stain resist composition but using magnesium sulfate as the stain resist enhancer did not show improved resistance to mustard stain versus the examples of the present invention. Comparative Example E with no stain resist agent present and sodium sulfate alone did not show a reduction of staining by mustard and BETADINE versus the example of the present invention. An increase of the level of the stain resist agent (Comparative Example B versus Comparative Examples C and D) did not result in an increase in stain resistance to mustard.

Examples 1-6, 8-11, and Comparative Examples A and C as described above were applied to carpet as detailed in Example 1. The carpet was stained with coffee and tested for stain resistance using Test Method 3. The resulting data listed on Table 2.

TABLE 2

| | Bath Contents and Concentrations | | | | |
|---|---|---|---|---|---|
| | Stain Resist | | | | |
| | (% owf*) | | | | Coffee |
| Ex. | (100% solids | | Enhancer | Bath | Stain |
| # | basis) | Stain Resist Enhancer | (g/L) | pH | Rating |

EXAMPLES

| | | | | | |
|---|---|---|---|---|---|
| 1 | 4 | Sodium sulfate | 25 | 3.0 | 4.5 |
| 6 | 4 | Sodium sulfate | 5 | 3.0 | 4.5 |
| 2 | 4 | p-toluene sulfonic acid | 5 | 3.0 | 4.5 |
| 8 | 4 | p-toluene sulfonic acid | 12.5 | 3.0 | 4.5 |
| 9 | 4 | p-toluene sulfonic acid | 25 | 3.0 | 4.5 |
| 5 | 4 | sodium p-toluene | 12.5 | 3.0 | 4.5 |
| | | sulfonic acid | | | |
| 3 | 4 | Sodium xylene sulfonate | 12.5 | 3.0 | 4.5 |
| 10 | 4 | Sodium xylene sulfonate | 25 | 3.0 | 4.5 |
| 4 | 4 | Urea | 5 | 3.0 | 4.5 |
| 11 | 4 | Urea | 25 | 3.0 | 4.5 |

COMPARATIVE EXAMPLES

| | | | | | |
|---|---|---|---|---|---|
| A | 0 | None | — | 3.0 | 1 |
| C | 4 | None | — | 3.0 | 4 |

Table 2 shows that stain resist compositions comprising a stain resist agent and one of sodium sulfate, p-toluene sulfonic acid, sodium p-toluene sulfonic acid, sodium xylene sulfonate, or urea as a stain resist enhancer showed excellent stain resistance to coffee stains. Comparative Example A containing no stain resist agent and no stain resist enhancer showed very poor resistance to staining by coffee. Comparative Example C containing the same stain resist agent and no stain resist enhancer showed decreased resistance to coffee staining.

Examples 1-5 and Comparative Examples A and C as described above were applied to carpet as detailed in Example 1. The carpet was stained with cherry KOOL-AID and tested for stain resistance using Test Method 4. The resulting data is listed in Table 3.

TABLE 3

| | Bath Contents and Concentrations | | | | |
|---|---|---|---|---|---|
| | Stain Resist | | | | KOOL- |
| | (% owf*) | | | | AID |
| Ex. | (100% | | Enhancer | Bath | Stain |
| # | solids basis) | Stain Resist Enhancer | (g/L) | pH | Rating |

EXAMPLES

| | | | | | |
|---|---|---|---|---|---|
| 1 | 4 | Sodium sulfate | 25 | 3.0 | 10 |
| 2 | 4 | p-toluene sulfonic acid | 5 | 3.0 | 10 |
| 5 | 4 | Sodium p-toluene | 12.5 | 3.0 | 10 |
| | | sulfonic acid | | | |
| 3 | 4 | Sodium xylene sulfonate | 12.5 | 3.0 | 10 |
| 4 | 4 | Urea | 5 | 3.0 | 10 |

COMPARATIVE EXAMPLES

| | | | | | |
|---|---|---|---|---|---|
| A | 0 | None | — | 3.0 | 1 |
| C | 4 | None | — | 3.0 | 10 |

Table 3 showed that stain resist compositions comprising a stain resist agent and one of sodium sulfate, p-toluene sulfonic acid, sodium p-toluene sulfonic acid, sodium xylene sulfonate, or urea as a stain release enhancer showed excellent stain resistance to KOOL-AID stains. Comparative Example A containing no stain resist agent or enhancer showed very poor resistance to staining by KOOL-AID. Comparative Example C containing the same stain resist agent and no enhancer showed performance comparable to the examples of the present invention, demonstrating that use of an enhancer is less effective for this type of stain compared to turmeric or BETADINE stains.

### Examples 24-25

Examples 24 and 25 were applied to carpet as described in Example 1 using the stain resist agent of Example 1 and the stain resist enhancer as shown in Table 4. A fluorochemical soil resist was also applied after the stain resist to the carpet samples. The carpet was stained with mustard and tested for stain resistance using Test Method 1. Test results are shown below in Table 4.

### Comparative Example F

The carpet sample was prepared, stained, and rated as described in Examples 24-25 except that no stain resist agent or stain resist enhancer was added to the bath. Test results are shown below in Table 4.

TABLE 4

| | Bath Contents and Concentrations | | | | |
|---|---|---|---|---|---|
| | Stain Resist | | | | |
| | (% owf*) | | | | Mustard |
| | (100% solids | | Enhancer | Bath | Stain |
| Ex. # | basis)% | Stain Resist Enhancer | (g/L) | pH | Delta E |

EXAMPLES

| | | | | | |
|---|---|---|---|---|---|
| 24 | 4 | Sodium sulfate | 25 | 3.0 | 3.00 |
| 25 | 4 | Urea | 5 | 3.0 | 3.03 |

COMPARATIVE EXAMPLES

| | | | | | |
|---|---|---|---|---|---|
| F | 0 | None | — | 3.0 | 36.71 |

Table 4 shows a reduction in the amount of staining by mustard with the use of sodium sulfate or urea as stain resist enhancers in the stain resist composition combined with application of soil resist to the carpet.

### Example 26

The stain resist composition of Example 1 was applied to Carpet 2 using a Beck exhaust application, with 30:1 bath:fiber ratio at pH 3.0 (adjusted with Autoacid A-10). The stain resist concentration was 15% (4% on a 100% solids basis) based on the weight of the dry fiber and sodium chloride was added to the bath as a stain resist enhancer to provide a concentration of 5 g/L. Cut carpet samples (4 to 6 inch squares, 10 to 15 cm) were immersed in the bath, and the bath temperature was raised to 190° F. (88° C.), then held at 190° F. (88° C.) for 15 min. Then the samples were removed from the application bath, rinsed with water, and dried. The samples were stained with mustard and tested for stain resistance using Test Method 1, and rated as described therein. The resulting data is shown in Table 5 below.

### Comparative Example G

The carpet sample was prepared, stained, and rated as described in Example 26 except that no stain resist agent or enhancing salts were added to the bath. Test results are shown below in Table 5.

### Comparative Example H

The carpet sample was prepared, stained, and rated as described in Example 26 except that no stain resist enhancer was added to the bath. Results are in Table 5.

TABLE 5

| | Bath Contents and Concentrations | | | | |
|---|---|---|---|---|---|
| | Stain Resist | | | | |
| | (% owf*) | | | | Mustard |
| | (100% solids | Stain Resist | Enhancer | Bath | Stain |
| Ex. # | basis) | Enhancer | (g/L) | pH | Delta E* |

EXAMPLES

| | | | | | |
|---|---|---|---|---|---|
| 26 | 4 | Sodium chloride | 5 | 3.0 | 10.90 |

COMPARATIVE EXAMPLES

| | | | | | |
|---|---|---|---|---|---|
| G | 0 | None | — | 3.0 | 68.73 |
| H | 4 | None | — | 3.0 | 13.71 |

*Lower delta E indicates superior stain resistance.

Table 5 shows a reduction in staining by mustard with the use of sodium chloride in the stain resist composition versus Comparative Example H using the same stain resist composition with no sodium chloride present as a stain resist enhancer. Comparative Example G containing no stain resist agent or enhancer showed severe staining with mustard.

### Examples 27

The carpet sample was prepared, stained, and rated as described in Example 26 using the stain resist composition of Example 1 except that 5 g/L of sodium phosphate was used in place of sodium chloride as the stain resist enhancer. The carpet was stained with mustard and tested for stain resistance using Test Method 1. Test results are shown below in Table 6.

### Comparative Examples I and J

Comparative Example I was prepared as comparative Example 26 but contained no stain resist agent or stain resist enhancer. Comparative Example J was prepared as Example 26 and contained the stain resist composition of Example 1 but no stain resist enhancer. The carpet was treated, stained, and tested using Test Method 1. Test results are shown in Table 6.

TABLE 6

| | Bath Contents and Concentrations | | | | |
|---|---|---|---|---|---|
| | Stain Resist | | | | |
| | (% owf*) | | | | Mustard |
| | (100% solids | Stain Resist | Enhancer | | Stain |
| Ex. # | basis) | Enhancer | (g/L) | Bath pH | Delta E |

EXAMPLES

| | | | | | |
|---|---|---|---|---|---|
| 27 | 4 | Sodium phosphate | 5 | 3.0 | 14.92 |

COMPARATIVE EXAMPLES

| | | | | | |
|---|---|---|---|---|---|
| I | 0 | none | — | 3.0 | 64.42 |
| J | 4 | none | — | 3.0 | 20.87 |

Table 6 shows a reduction in staining by mustard with the use of sodium phosphate or calcium sulfate as stain resist enhancer in the stain resist composition versus Comparative Example J containing no stain resist enhancer. Comparative Example I containing no stain resist agent or enhancer showed severe staining.

### Examples 28-30

A stain resist composition was prepared containing 2.6% by weight of hydrolyzed styrene/maleic anhydride/methyl styrene copolymer, 6.9% by weight partial sodium salt of a hydrolyzed octene/maleic anhydride copolymer, 12.3% by weight of sulfonated phenol-formaldehyde condensate, 4.5% by weight of sodium dodecyl diphenyloxide disulfonate, and 73.8% water. Carpet 1 was treated with this stain resist composition using the process described in Example 1. p-Toluene sulfonic acid, sodium xylene sulfonate, and sodium p-toluene sulfonic acid were used as the stain resist enhancer in place of sodium sulfate. The carpet was stained with mustard and tested for stain resistance in accordance with Test Method 1. Test results are shown in Table 7.

### Comparative Example K

Comparative Example K carpet sample was treated, stained and rated as described for Examples 28-30 with the exception that no stain resist enhancer was employed. The carpet was stained with mustard and tested for stain resistance in accordance with Test Method 1. Test results are shown in Table 7.

TABLE 7

| | Bath Contents and Concentrations | | | | |
|---|---|---|---|---|---|
| | Stain Resist | | | | |
| | (% owf*) | | | | Mustard |
| Ex. | (100% solids | | Enhancer | Bath | Stain |
| # | basis) | Stain Resist Enhancer | (g/L) | pH | Rating |

EXAMPLES

| | | | | | |
|---|---|---|---|---|---|
| 28 | 4 | p-toluene sulfonic acid | 5 | 3.0 | 9 |
| 29 | 4 | Sodium xylene sulfonate | 12.5 | 3.0 | 8 |
| 30 | 4 | Sodium | 12.5 | 3.0 | 8 |
| | | p-toluene sulfonic acid | | | |

COMPARATIVE EXAMPLE

| | | | | | |
|---|---|---|---|---|---|
| K | 4 | none | — | 3.0 | 7 |

Table 7 shows that stain resist compositions of the present invention with p-toluene sulfonic acid, sodium xylene sulfonate, or sodium p-toluene sulfonic acid showed a reduction in staining by mustard stains versus Comparative Example K.

### Examples 31-38

A stain resist composition was prepared containing 1.25% by weight of hydrolyzed styrene/maleic anhydride/methyl styrene copolymer, 25.5% by weight of sulfonated phenol formaldehyde condensate, 2.7% by weight of sodium dodecyl diphenyloxide disulfonate, and 70.55% by weight water. These weights are on a 100% solids basis. Carpet 1 was treated with the stain resist composition using the process described in Example 1. p-Toluene sulfonic acid and urea were used as the stain resist enhancers in place of sodium sulfate for Examples 31-36 as listed in Table 8. The carpet was stained with mustard and tested for stain resistance in accordance with Test Method 1. Test results are in Table 8.

### Comparative Example L

Comparative Example L carpet sample was prepared, stained, and rated as described for Examples 31-38 with the exception that no stain resist enhancer was employed. The carpet was stained with mustard and tested for stain resistance in accordance with Test Method 1. Test results are in Table 8.

### Comparative Example M

Comparative Example M carpet sample was prepared, stained, and rated as described for Examples 31-38 with the exceptions that magnesium sulfate was used as the stain resist enhancer instead of sodium sulfate. The carpet was stained with mustard and tested for stain resistance in accordance with Test Method 1. Test results are in Table 8.

TABLE 8

| | Bath Contents and Concentrations | | | | |
|---|---|---|---|---|---|
| | Stain Resist | | | | |
| | (% owf*) | | | | Mustard |
| | (100% solids | | Enhancer | Bath | Stain |
| Ex. # | basis) | Stain Resist Enhancer | (g/L) | pH | Rating |

EXAMPLES

| | | | | | |
|---|---|---|---|---|---|
| 31 | 4 | p-toluene sulfonic acid | 5 | 3.0 | 8 |
| 32 | 4 | p-toluene sulfonic acid | 5 | 4.5 | 7 |
| 33 | 4 | p-toluene sulfonic acid | 5 | 6 | 6 |
| 34 | 4 | Urea | 12.5 | 3.0 | 7 |
| 35 | 4 | Urea | 12.5 | 4.5 | 7 |
| 36 | 4 | Urea | 12.5 | 6 | 6 |
| 37 | 4 | Sodium sulfate | 25 | 3.0 | 4 |
| 38 | 4 | Sodium sulfate | 25 | 4.5 | 4 |

COMPARATIVE EXAMPLES

| | | | | | |
|---|---|---|---|---|---|
| L | 4 | None | — | 3.0 | 3 |
| M | 4 | Magnesium sulfate | 12.5 | 3.0 | 3 |

Table 8 shows that stain resist compositions of the present invention with sodium sulfate, p-toluene sulfonic acid, or urea as a stain resist enhancer showed a reduction in staining by mustard versus Comparative Example L with no stain resist enhancer. Comparative Example M with the same stain resist composition and magnesium sulfate as the stain resist enhancer did not show a reduction in mustard staining versus Comparative Example L.

### Example 39 and Comparative Example N

Example 39 was prepared, stained, and rated as described in Example 1 except that sulfonated phenol-formaldehyde condensate was used as the stain resist, and sodium chloride was used as the stain resist enhancer in place of sodium sulfate.

Comparative Example N was prepared as described for Comparative Example C with the exception that sulfonated phenol-formaldehyde condensate was used as the stain resist agent. No stain resist enhancer was present.

The above Examples were applied to carpet using the process described in Example 1 and tested for stain resistance according to Test Methods 1 and 2. Test results for Example 39 and Comparative Example N are in Table 9.

TABLE 9

| | Bath Contents and Concentrations | | | | | |
|---|---|---|---|---|---|---|
| | Stain Resist | | | | | |
| | (% owf*) | Stain | | | Mustard | |
| Ex. | (100% | Resist | Enhancer | Bath | Stain | BETADINE |
| # | solids basis) | Enhancer | (g/L) | pH | Rating | Stain Rating |

EXAMPLE

| | | | | | | |
|---|---|---|---|---|---|---|
| 39 | 4 | Sodium | 5 | 3.0 | 8 | NT |
| | | chloride | | | | |

COMPARATIVE EXAMPLE

| | | | | | | |
|---|---|---|---|---|---|---|
| N | 14 | None | — | 3.0 | 6 | 1 |

Table 9 shows that a stain resist composition comprising a) sulfonated phenol-formaldehyde condensate and b) sodium chloride which was applied at pH 3 showed an improvement in reduction to staining by mustard vs. Comparative Example N which did not contain the salt.

What is claimed is:

1. A medium containing a composition comprising at least one stain resist agent and at least one stain resist enhancer, said enhancer comprising at least one of urea; biuret; alkyl carbamate; and cyclic amide of formic acid, of C₂ to C₆ alkanoic acids, or of C₃ to C₆ alkandioic acids, said composition reducing turmeric stains or iodine complex stains; wherein
a) the amount of stain resist enhancer present in the medium is at least 2.5 g/L to about 35 g/L; and
b) the stain resist agent comprises a sulfonated phenolic resin or condensate, a partially sulfonated novalac resin, a polymer or copolymer of methacrylic acid or esters thereof, a copolymer of maleic anhydride with olefin or vinyl ether, a hydrolyzed ethylenically unsaturated aromatic/maleic anhydride polymer, and combinations thereof.

2. The composition of claim 1 wherein the enhancer is a caprolactam, malonamide, succinamide, succinimide, or alkyl carbamate.

3-6. (canceled)

7. The composition of claim 1 wherein the ratio of stain resist enhancer to stain resist agent is from about 1:0.7 to about 1:0.02.

8. The composition of claim 1 further comprising a compound or composition that provides a surface effect selected from the group consisting of no iron, easy to iron, shrinkage control, wrinkle free, permanent press, moisture control, softness, strength, anti-slip, anti-static, anti-snag, anti-pill, stain repellency, stain release, odor control, antimicrobial, and sun protection.

9. The composition of claim 1 further comprising surfactants, sequestering agents, leveling agents, pH adjusters, cross linkers, wetting agents, blocked isocyanates, hydrocarbon extenders, and wax extenders.

10. The composition of claim 1 in the form of a solution or dispersion.

11. A method for providing stain resistance to turmeric or iodine complexes in substrates comprising contacting the substrate with the medium of claim 1.

12. The method of claim 11 wherein the contacting comprises use of exhaustion, Flex-nip, pad, spray, or foam application.

13. (canceled)

14. The method of claim 11 wherein the enhancer is a caprolactam, malonamide, succinamide, succinimide, or alkyl carbamate.

15. The method of claim 11 wherein the stain resist agent comprises a sulfonated phenolic resin or condensate, a partially sulfonated novalac resin, a polymer or copolymer of methacrylic acid or esters thereof, a copolymer of maleic anhydride with olefin or vinyl ether, a hydrolyzed ethylenically unsaturated aromatic/maleic anhydride polymer, and combinations thereof.

16. A substrate to which has been applied a composition according to the method of claim 11.

17. The substrate of claim 16 comprising a fibrous substrate.

18. The substrate of claim 16 which is a fiber, fabric, fabric blend, carpet, textile, nonwoven, leather or paper.

19. The substrate of claim 18 which is comet.
